(19) United States
(12) Patent Application Publication
(10) Pub. No.: US 2012/0275737 A1
(43) Pub. Date: Nov. 1, 2012

(54) BEARING ASSEMBLY HAVING AN INTERNAL OIL MIST GENERATOR

(75) Inventor: Ferdinand Schweitzer, St. Peter in der Au (AT)

(73) Assignee: AKTIEBOLAGET SKF, Goteborg (SE)

(21) Appl. No.: 13/455,230

(22) Filed: Apr. 25, 2012

(30) Foreign Application Priority Data
Apr. 29, 2011 (DE) 10 2011 017 766.3

(51) Int. Cl. F16C 33/66; F16C 19/26

(52) U.S. Cl. 384/468

(57) ABSTRACT

A rolling element bearing includes a plurality of rolling elements disposed between at least one bearing inner ring and at least one bearing outer ring. A cage retains and guides the rolling elements between the at least one bearing inner ring and the at least one bearing outer ring. An annular extension extends from the cage. The annular extension has a rectangular contour when viewed in radial cross-section and has a surface roughness (Rₐ) less than seven μm. The annular extension extends at least three millimeters into lubricating oil disposed in an oil reservoir adjacent to the annular extension and generates an oil mist when one of the at least one bearing inner ring and at least one bearing outer ring rotates relative to the other.

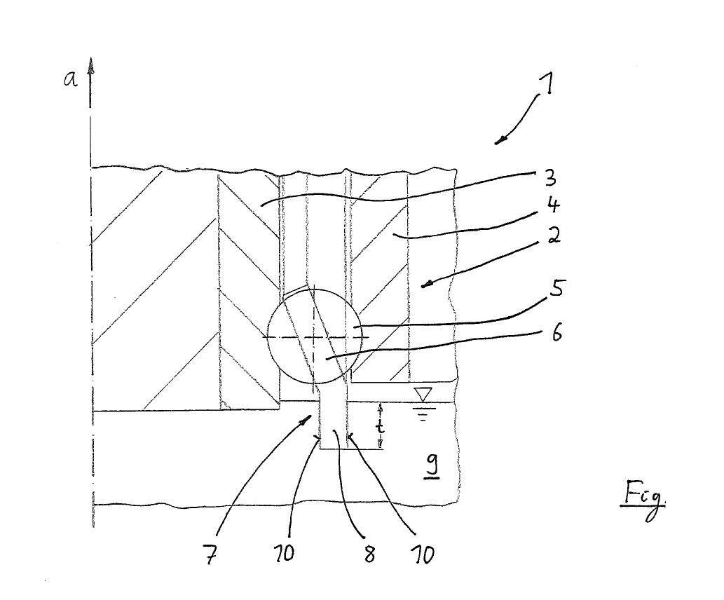

### CROSS-REFERENCE

The application claims priority to German patent application no. 10 2011 017 766.3 filed on Apr. 29, 2011, the contents of which are fully incorporated herein by reference.

### TECHNICAL FIELD

The invention relates to a bearing assembly comprising a roller element bearing and an oil mist generator that generates an oil mist when at least one of the bearing rings of the rolling element bearing rotates.

### BACKGROUND

A bearing assembly having an oil mist generator is disclosed, e.g., in WO 2007/040427 A1. This reference proposes to dispose an oil mist generating element on a bearing ring that is immersed in an oil bath. When the bearing ring rotates, the element immersed in the oil induces the creation of an oil mist.

U.S. Pat. No. 5,312,191, U.S. Pat. No. 2,447,671, EP 1 767 800 A1, U.S. Pat. No. 3,612,631 and EP 0 215 858 B1 also disclose bearing assemblies with oil mist generating means.

An optimal lubrication of the rolling element bearing can be achieved by the oil mist generated thereby, such that the service life of the bearing can be increased.

### SUMMARY

It is an object of the present teachings to disclose an improved bearing assembly of the above-mentioned type, in which the desired oil mist can be generated within the bearing assembly in a more simple and efficient manner. Thus, the oil mist generation can take place in a more cost-effective manner.

In one aspect of the present teachings, a bearing assembly comprises a roller element bearing having at least one bearing inner ring and at least one bearing outer ring. A plurality of rolling elements is disposed between the bearing inner ring and the bearing outer ring. The rolling elements are held and guided by a cage disposed between the inner and outer rings of the bearing. Furthermore, means are provided for generating an oil mist during the rotation of at least one of the bearing rings of the rolling element bearing. More particularly, the means for generating the oil mist is preferably formed by at least one segment disposed on the cage, which at least one segment is immersed in lubricating oil that is filled into the bearing assembly. Even more preferably, the at least one segment has an annular shape and includes a right-angled contour in radial cross-section. Furthermore, the at least one segment preferably has a smooth surface with a surface roughness preferably less than Rₐ=7 μm (Rₐ=roughness depth).

In another aspect of the present teachings, the at least one segment is preferably integrally formed as one-piece with the part forming the cage.

In addition or in the alternative, the segment preferably extends in the direction of the rotational axis of the rolling element bearing.

In addition or in the alternative, the segment preferably includes sharp or acute edges, which promote a turbulent flow when the segment is driven through the oil.

In addition or in the alternative, the surface roughness of the segment is preferably less than Rₐ=3.5 μm. The surface roughness of the segment is, however, also preferably greater than Rₐ=0.5 μm, more preferably greater than Rₐ=0.8 μm.

In addition or in the alternative, the at least one segment is configured to be immersed in the lubricating oil at a depth of preferably at least 3 mm, more preferably at least 5 mm. It is advantageous if a largest-possible immersion depth of the segment on the cage occurs in the oil reservoir.

The generation of the oil mist is promoted when smooth surfaces are provided on the immersed portion of the segment; ribs are to be avoided as much as possible.

A cage having the at least one segment according to the present teachings thus serves as an efficient oil mist generator. This oil mist can be continuously generated during the operation of the bearing assembly and thus always provides an optimal lubrication.

The size of the oil tank or reservoir is of minor importance. Accordingly, advantageous oil mist generating effects are achievable even with small oil volumes.

According to a preferred embodiment of the present teachings, the self-generated oil mist lubrication may be generated by forming a trough-like reservoir—preferably in the shape of an annular trough—underneath the bearing. The lubricating oil is disposed in this annular reservoir during operation of the roller element bearing. The annular oil reservoir can be formed by a seal element, e.g., by a seal ring.

The lower portion of the at least one segment of the cage is immersed in the oil bath during operation of rolling element bearing, such that a vortex is generated underneath the upper surface of the oil bath when the cage rotates. The geometry underneath the bath surface is also important, because a turbulent flow can form here and no laminar flow prevails. In this respect, a sharp-edged (or acute-edged) design is preferable so that turbulent vortex flows can emanate from the revolving sharp-edged corners.

Rotational roughness depths of Rₐ=0.8 μm to 3.2 μm have proven themselves to be particularly advantageous. However, higher values (up to Rₐ=25 μm) are also suitable in certain aspects of the present teachings. It is important that no mixing of the oil takes place; the flow should remain relatively calm. This is also substantially facilitated by the condition that the cage rotates not at the bearing ring rotational speed, but rather at a lower rotational speed (in particular at one-half the bearing ring rotational speed). As a result, the generation of the oil mist generation can be better controlled.

The field of application of the present teachings is broad. For example, the present design has proven itself to be advantageous when used in a centrifugal separator (i.e. when utilized with a bearing that supports the rotating shaft of the centrifugal separator), which is utilized in the food industry. Likewise, tool machines are, e.g., a possible field of application.

The bearing can, in principle, be grease lubricated. The initial greasing typically suffices as the bearing lubrication for about one thousand operation hours. The internal oil mist generator according to the present teachings generally functions independent of the grease and guides fresh oil mist to the bearing point, i.e. to the rolling elements. Preferably, the base oil of the rolling element grease is utilized as an oil.

The oil level (as viewed in the vertical state) is set so that the seal lip upper edge of a seal (which forms, e.g., the annular trough-shaped oil reservoir) is not overfilled and the oil thus does not overflow out of the seal. More preferably, a contact seal is preferably used and is designed so that that the seal functions in a contacting manner up to seal lip sliding speeds of 90 m/s. All typical embodiments (e.g., back-to-back, face-to-face, tandem) can be realized by disposing the rolling element bearings in a corresponding manner.

The present teachings can be utilized with all types of roller element bearings, including e.g., deep groove ball bearings.

According to the present teachings, a bearing assembly design is proposed that ensures a maintenance-free operation by always generating the necessary oil film internally within the bearing when the bearing is in operation.

Further objects, embodiments, designs and advantages of the present teachings will be apparent after reviewing the following detailed description and appended claims in view of the drawing.

### BRIEF DESCRIPTION OF THE DRAWINGS

An exemplary embodiment of the invention is illustrated in the FIGURE, which shows a radial cross-section through a part of a bearing assembly.

### DETAILED DESCRIPTION OF THE INVENTION

A bearing assembly 1 is illustrated in the Figure and includes a rolling element bearing 2 having a bearing inner ring 3 and a bearing outer ring 4. Rolling elements 5, in the present embodiment—balls, are disposed between the bearing rings 3, 4 in a known manner. The rolling elements 5 are held and guided by a cage 6 disposed between the bearing rings 3, 4.

During the operation (rotation) of the rolling element bearing 2, one of the bearing rings rotates about the rotational axis a. In the present embodiment, the rotational axis a is vertically oriented.

Means 7 are provided, with which an oil mist can be generated during operation of the bearing assembly 1, i.e. when one of the bearing rings rotates relative to the other. In the present embodiment, the oil mist generating means 7 is formed by a segment 8 that is disposed on (extends from) the cage 6 and is formed integrally (in one piece) with the cage 6. That is, the segment 8 and the cage 6 are integrally formed without any seam(s) therebetween. The segment 8 has an annular shape and at least portion of the segment 8 is immersed in the lubricating oil 9 at an immersion depth t, preferably at least 3 mm, more preferably at least 5 mm. The lubricating oil 9 is filled to a suitable depth in an oil reservoir of the bearing assembly, which may be defined by the annular trough-shaped contact seal that was described above.

The segment 8 is provided with one or more sharp or acute edges 10, which ensures that a stall occurs in the fluid flow within the oil when the segment 8 is driven through the lubricating oil 9 at the appropriate speed. In this case, a turbulent flow will form in the lubricating oil. As a result, the desired and intended oil mist is formed. The segment 8 preferably has the surface roughness and shape as described above.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved roller bearing assemblies and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Bearing assembly
2 Roller bearing
3 Bearing inner ring
4 Bearing outer ring
5 Rolling element (ball)
6 Cage
7 Means for generating an oil mist
8 Segment
9 Lubricating oil
10 Edge
a Rotational axis of the rolling element bearing
t Immersion depth

1. A bearing assembly comprising:
a rolling element bearing having a plurality of rolling elements disposed between at least one bearing inner ring and at least one bearing outer ring, the rolling elements being held by a cage, and
means for generating an oil mist when there is relative rotation between the least one bearing inner ring and the at least one bearing outer ring, the oil mist generating means being formed by at least one annular segment that is arranged on the cage and is immersed in lubricating oil filled into the bearing assembly, wherein the at least one annular segment has a right-angled contour in radial cross-section and has a smooth surface with a surface roughness of less than Rₐ=7 μm.

2. The bearing assembly according to claim 1, wherein the segment is integrally formed with the cage as one-piece without seams therebetween.

3. The bearing assembly according to claim 2, wherein the rolling element bearing has a rotational axis and the at least one annular segment extends in parallel with the rotational axis of the rolling element bearing.

4. The bearing assembly according to claim 3, wherein the at least one annular segment has at least one sharp edge configured to be immersed in the lubricating oil.

5. The bearing assembly according to claim 4, wherein the surface roughness of the at least one annular segment is less than Rₐ=3.5 μm.

6. The bearing assembly according to claim 5, wherein surface roughness of the at least one annular segment is greater than Rₐ=0.5 μm.

7. The bearing assembly according to claim 6, wherein surface roughness of the at least one annular segment is greater than Rₐ=0.8 μm.

8. The bearing assembly according to claim 7, further comprising an oil reservoir adjacent to the at least one annular segment, wherein the at least one annular segment is configured to extend at least 3 millimeters into the lubricating oil disposed in the oil reservoir.

9. The bearing assembly according to claim 8, wherein the segment is configured to extend at least 5 millimeters into the lubricating oil disposed in the oil reservoir.

10. The bearing assembly according to claim 1, wherein the rolling element bearing has a rotational axis and the at least one annular segment extends in parallel with the rotational axis of the rolling element bearing.

11. The bearing assembly according to claim 1, wherein the at least one annular segment includes at least one sharp edge configured to be disposed in the lubricating oil.

12. The bearing assembly according to claim 1, wherein the surface roughness of the at least one annular segment is less than Rₐ=3.5 μm.

13. The bearing assembly according to claim 1, wherein surface roughness of the at least one annular segment is greater than Rₐ=0.5 μm.

14. The bearing assembly according to claim 1, wherein surface roughness of the at least one annular segment is greater than Rₐ=0.8 μm.

15. The bearing assembly according to claim 1, further comprising an oil reservoir adjacent to the at least one annular segment, wherein the at least one annular segment is configured to extend at least 3 millimeters into the lubricating oil disposed in the oil reservoir.

16. The bearing assembly according to claim 15, wherein the at least one annular segment is configured to extend at least 5 millimeters into the lubricating oil disposed in the oil reservoir.

17. A rolling element bearing comprising:
a plurality of rolling elements disposed between at least one bearing inner ring and at least one bearing outer ring,
a cage retaining and guiding the rolling elements between the at least one bearing inner ring and the at least one bearing outer ring, and
an annular extension extending from the cage in an axial direction of the rolling element bearing, the annular extension having a rectangular contour when viewed in radial cross-section and having a surface roughness less than Rₐ=7 μm, the annular extension being configured to extend at least 3 millimeters into lubricating oil disposed in an oil reservoir adjacent to the annular extension and to generate an oil mist when one of the at least one bearing inner ring and at least one bearing outer ring rotates relative to the other.

18. The rolling element bearing according to claim 17, wherein surface roughness of the annular extension is between 0.8 μm and 3.2 μm.

19. The rolling element bearing according to claim 18, wherein the annular extension extends in parallel with a rotational axis of the rolling element bearing.

20. The rolling element bearing according to claim 19, wherein the rotational axis extends at least substantially vertically and the annular extension is configured to extend at least 5 millimeters into the lubricating oil disposed in the oil reservoir.
